(19) United States
(12) Patent Application Publication
(10) Pub. No.: US 2010/0220987 A1
(43) Pub. Date: Sep. 2, 2010

(54) IMAGING DEVICE AND PORTABLE TERMINAL WITH THIS

(75) Inventors: Akihiko Kato, Kanagawa (JP); Norihiko Kikuchi, Kanagawa (JP); Takashi Kusakari, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/997,507

(22) PCT Filed: Jul. 14, 2006
(86) PCT No.: PCT/JP2006/314038

§ 371 Date: Jan. 31, 2008

(30) Foreign Application Priority Data
Aug. 4, 2005 (JP) 2005-226778

(51) Int. Cl. G03B 3/10

(52) U.S. Cl. 396/133

(57) ABSTRACT

It is an object of the present invention to provide an imaging device that can be reduced in production cost in comparison with the conventional imaging device, and a portable terminal provided with the imaging device. The imaging device 10 comprises a lens 11 for focusing light from an object, a magnet 12 attached to the lens 11, lens moving means 13 for moving the lens 11 along an optical axis of the lens 11, a hall element 14 for detecting a magnetic flax generated by the magnet 12, a constant current circuit 15 for driving the hall element 14, an amplifier 16 for amplifying an output voltage of the hall element 14, a comparator 17 for comparing a reference voltage with the output voltage of the hall element 14, a PWM signal producing unit 18 for producing a pulse width modulation signal, a lens controller 19 for outputting a control signal to the lens moving means 13 to control the lens moving means 13, and a lens driver 20 for driving the lens moving means 13.

### TECHNICAL FIELD OF THE INVENTION

The present invention relates to an imaging device and a portable terminal provided with the imaging device.

### DESCRIPTION OF THE DEPENDENT ART

In recent years, there has been introduced on the market a wide variety of mobile phones each having an imaging device offering two millions or more pixels with progressed image compression technology and advanced imaging sensor. The imaging device of this type has an autofocusing mechanism, an automatic white balance adjusting mechanism, an automatic iris adjusting mechanism and the like.

The autofocusing mechanism can focus a lens on an object by automatically moving the lens when a distance from the lens to the object is within an allowable range. On the other hand, the autofocusing mechanism cannot focus the lens on an object when a distance from the lens to the object is not within the allowable range. Therefore, it is necessary to control the autofocusing mechanism to allow the autofocusing mechanism to move the lens within the allowable range, and to prevent the lens from being moved beyond the allowable range, bumping against elements, and being damaged by elements mounted to the housing.

As an example of a method of detecting two limiting points collectively defining a range over which the lens functions in a normal manner, there has been known a method of detecting two limiting points by using a photointerrupter as shown in FIGS. 5(a) and (b) (see a patent document 1). One of the limiting points is hereinafter referred to as “near end”, while the other of the limiting points is hereinafter referred to as “infinite end”.

FIG. 5(a) is a block diagram showing a conventional imaging device disclosed in a patent document 1. FIG. 5(b) is a waveform chart showing an output signal to be outputted by a photointerrupter. As shown in FIG. 5(a), the conventional imaging device comprises a lens 1, an image sensor 2, a photointerrupter 3, a screw 4 for adjusting a position of the photointerrupter 3, and a lightproof plate 5 attached to the lens 1. When the lens 1 takes the near end or the infinite end, the lightproof plate 5 prevents the photointerrupter 3 from receiving a light.

In the conventional imaging device thus constructed, the lens 1 is moved with the lightproof plate 5. When the lens 1 is about to move beyond an infinity-related position and a macro-related position, the lightproof plate 5 prevents the photointerrupter 3 from receiving a light and allows the photointerrupter 3 to output a signal indicative of “low” as shown FIG. 5(b). Therefore, the conventional imaging device can detect whether or not the lens 1 is in the infinity-related position or the macro-related position under the condition that each of the infinity-related and macro-related positions is fixed as a position in which the output signal of the photointerrupter 3 is switched, in signal level, from “high” to “low”. Patent document 1: Jpn. unexamined patent publication No. 2002-341226

### DISCLOSURE OF THE INVENTION

### Problems to be solved by the Invention

The conventional imaging device, however, encounters such a problem that it is essential to adjust the position of the photointerrupter 3 by manually turning the screw 4 in assembling and adjusting stage by reason that the conventional imaging device is adapted to detect the limiting points of the lens 1 by using the photointerrupter 3 and the lightproof plate 5. Accordingly, the conventional imaging device cannot be reduced in production cost.

It is, therefore, an object to provide an imaging device that can be reduced in production cost in comparison with the conventional imaging device, and a portable terminal provided with the imaging device.

### Means for Solving the Problems

The imaging device according to present invention comprises: a lens for focusing light from an object; lens moving means for moving the lens along an optical axis of the lens; magnetic flux generating means for generating a magnetic flux at a position corresponding to a current position of the lens; and position-related voltage outputting means for detecting the magnetic flux, and outputting a position-related voltage indicative of the current position of the lens.

The imaging device thus constructed as previously mentioned according to the present invention can be reduced in production cost in comparison with the conventional imaging device and improved in assembling and adjusting stage by reason that the position-related voltage outputting means is adapted to output a voltage indicative of the current position of the lens in response to the magnetic flux, and the lens moving means is adapted to move the lens along the optical axis of the lens on the basis of the voltage related to the current position of the lens.

The imaging device according to present invention may further comprise infinity-related position detecting means for detecting an infinity-related position on the basis of a first reference voltage and the position-related voltage, and macro-related position detecting means for detecting a macro-related position on the basis of a second reference voltage and the position-related voltage.

The imaging device thus constructed as previously mentioned according to the present invention can allow the infinity-related position detecting means to detect whether or not the current position of the lens is equal to an infinity-related position, and allow the macro-related position detecting means to detect whether or not the current position of the lens is equal to a macro-related position.

In the imaging device according to present invention, the lens moving means may be adapted to move the lens along the optical axis of the lens within a range defined by the infinity-related position and the macro-related position.

The imaging device thus constructed as previously mentioned according to the present invention can prevent the lens from being moved beyond the range intervening between the infinity-related position and the macro-related position, bumping against elements and being damaged by elements mounted to the housing by reason that the lens moving means is adapted to move the lens along the optical axis of the lens within a range defined by the infinity-related position and the macro-related position.

The imaging device according to present invention may further comprise pulse width modulation signal producing means for producing pulse width modulation signals different in duty ratio from each other, and reference voltage producing means for producing the first and second reference voltages by smoothing the pulse width modulation signals.

The imaging device thus constructed as previously mentioned according to the present invention can produce first and second reference voltages with ease by further comprising reference voltage producing means for producing the first and second reference voltages by smoothing the pulse width modulation signal.

In the imaging device according to the present invention, the position-related voltage to be produced by the position-related voltage outputting means is dependent on ambient temperature of the position-related voltage outputting means. The imaging device according to the present invention may further comprise temperature compensation means for performing temperature compensation of the position-related voltage in response to the ambient temperature of the position-related voltage outputting means.

The imaging device thus constructed as previously mentioned according to the present invention can allow the infinity-related position detecting means to detect whether or not the current position of the lens is equal to an infinity-related position, and allow the macro-related position detecting means to detect whether or not the current position of the lens is equal to a macro-related position with accuracy by further comprising temperature compensation means for compensating for changes of the conversion characteristics.

The imaging device according to the present invention further comprises chattering noise preventing means for preventing the infinity-related position detecting means from being affected by a chattering noise at the time of detecting the infinity-related position, and preventing the macro-related position detecting means from being affected by a chattering noise at the time of detecting the macro-related position.

The imaging device thus constructed as previously mentioned according to the present invention can allow the infinity-related position detecting means to detect whether or not the lens is in the infinity-related position, and allow the macro-related position detecting means to detect whether or not the lens is in the macro-related position without being affected by a chattering noise or other external noises.

The portable terminal according to the present invention comprises the above-mentioned imaging device.

The portable terminal thus constructed as previously mentioned according to the present invention can be reduced in production cost and improved in assembling and adjusting stage in comparison with the conventional portable terminal by reason that the position of the lens are automatically adjusted in assembling and adjusting stage.

### Advantageous Effect of the Invention

The present invention can provide an imaging device which can be reduced in production cost and improved in assembling and adjusting stage in comparison with the conventional imaging device, and a portable terminal provided with the imaging device.

### BRIEF DESCRIPTION OF THE DRAWINGS

FIG. 1 is a block diagram showing a general constriction of an imaging device according to an embodiment of the present invention.

FIG. 2 is a circuit diagram showing one example of a circuit configuration of the imaging device according to the embodiment of the present invention.

FIG. 3(a) is a circuit diagram showing a comparator and its surrounding elements of the imaging device according to the embodiment of the present invention. FIG. 3(b) is a waveform chart showing a pulse width modulation (PWM) signal to be produced in the imaging device according to the embodiment of the present invention.

FIG. 4 is a waveform chart showing an example of an output voltage of a hall element to a position of a lens of the imaging device according to the embodiment of the present invention.

FIG. 5(a) is a block diagram showing a general construction of a conventional imaging device. FIG. 5(b) is a waveform chart showing an output signal of a photointerrupter of the conventional imaging device.

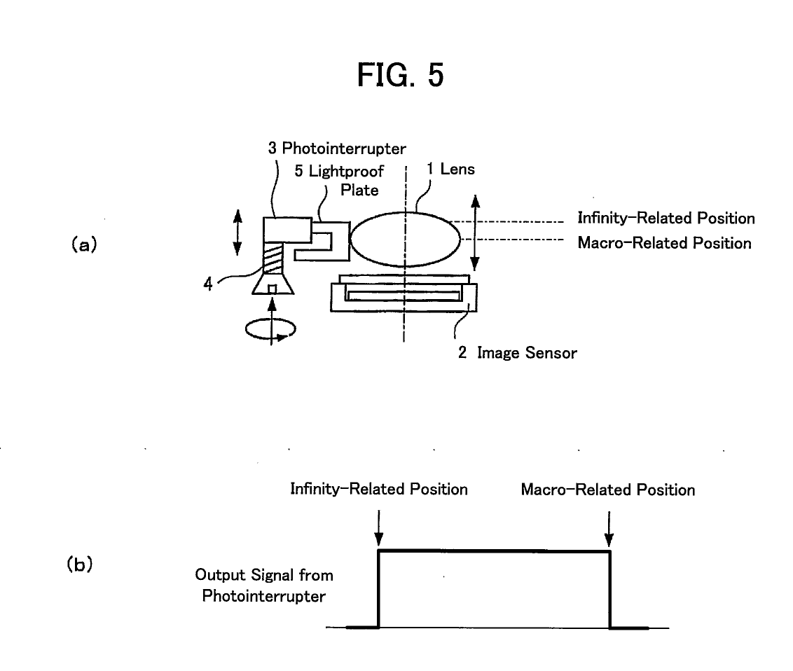

### EXPLANATION OF THE REFERENCE NUMERALS

10: imaging device
11: lens
12: magnet (magnetic flux generating means)
13: lens moving means
14: hall element (position-related voltage outputting means)
15: constant current circuit
16: amplifier
17: comparator (infinite position detecting means, macro position detecting means)
17a: comparator (infinite position detecting means)
17b: comparator (macro position detecting means)
18: PWM signal unit (pulse width modulation generating means, reference voltage producing means)
19: lens controller
20: lens driver
21: electric source terminal
22: diode (temperature compensation means)
23 to 25, and 27 to 32: resister
36: amplifier
33: resister (reference voltage producing means)
34: capacitor (reference voltage producing means)
35: resister (reference voltage producing means)
36: capacitor (reference voltage producing means)

### DESCRIPTION OF THE PREFERRED EMBODIMENTS

The embodiment of the imaging device according to the present invention will be described hereinafter with reference to accompanying drawings.

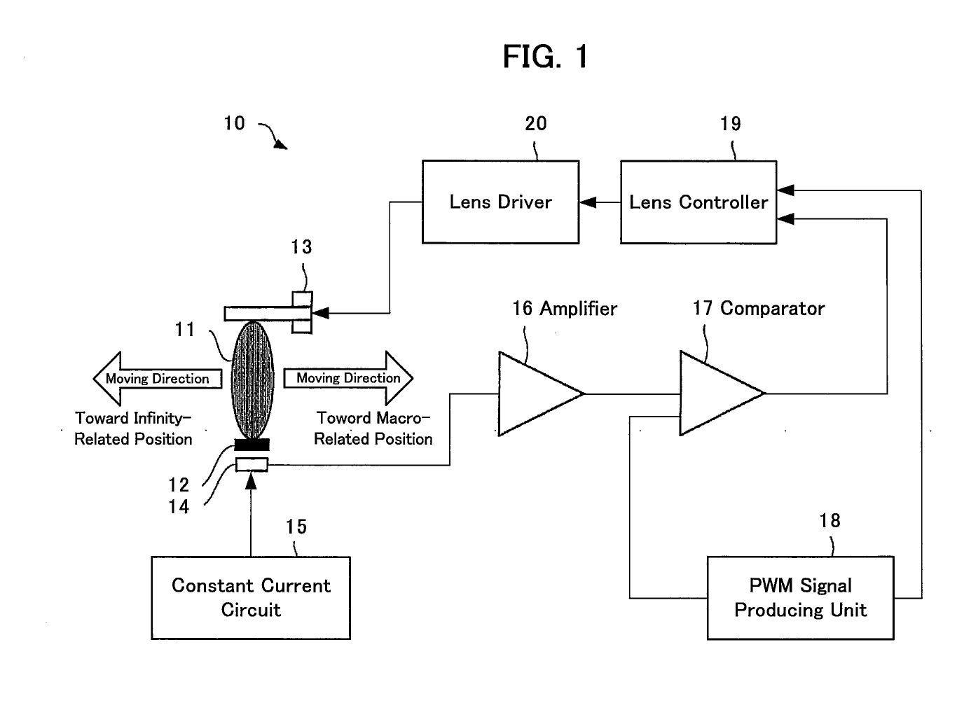

The following description is directed to the construction of the imaging device according to the embodiment of the present invention. FIG. 1 is a block diagram showing a general construction of the imaging device according to the embodiment of the present invention.

As shown in FIG. 1, the imaging device 10 comprises a lens 11 for focusing light from an object, a magnet 12 attached to the lens 11, lens moving means 13 for moving the lens 11 along an optical axis of the lens 11, a hall element 14 for detecting a magnetic flax generated by the magnet 12, a constant current circuit 15 for driving the hall element 14, an amplifier 16 (hall amplifier) for amplifying an output voltage of the hall element 14, a comparator 17 (hall comparator) for comparing a reference voltage with the output voltage of the hall element 14, a PWM signal producing unit 18 for producing a pulse width modulation (hereinafter referred to as “PWM”) signal, a lens controller 19 for controlling the lens moving means 13 by outputting a control signal to the lens moving means 13, and a lens driver 20 for driving the lens moving means 13.

Here, the magnet 12 functions as magnetic flux generating means, while the hall element 14 functions as position-related voltage outputting means.

The lens 11 is constituted by one or more lens made of plastic, glass, or the like. The magnet 12 is attached to, and fixed with respect to the lens 11. However, the imaging device may further comprise, for example, a frame for retaining the lens 11. The magnet 12 may be attached to, and fixed with respect to the frame.

The lens moving means 13 includes, for example, a piezoelectric element for moving the lens 11 between an infinity-related position and a macro-related position in response to an electric signal from the lens driver 20.

The hall element 14 functions as a magneto-electric transducer on the basis of the Hall effect, while the constant current circuit 15 is adapted to drive the hall element 14 by applying a constant current “IC” to the hall element 14. When the constant current circuit 15 supplies a constant current “IC” to the hall element 14, and the magnet 12 produces a magnetic flax acting on the hall element 14 under the condition that the magnetic flax “B” is perpendicular in direction to the constant current “IC”, the output voltage “VH” of the hall element 14 is represented by a follow relational expression.

VH=RH/d×IC×B (1)

Here, legends “RH” and “d” are respectively intended to indicate a hall coefficient and a thickness of the hall element.

The hall element 14 attached to for example a housing is adapted to output a voltage in response to the magnetic flax from the magnet 12 attached to the lens 11, the magnet 12 being movable together with the lens 11. The magnetic flax to be detected by the hall element 14 is dependent on the current position of the lens 11 by reason that the magnet 12 is moved along the optical axis of the lens 11 with the lens 11. Therefore, the hall element 14 can output, as a position-related voltage, a voltage related to the current position of the lens 11 in response to the magnetic in response to the magnetic flax from the magnet 12 attached to the lens 11.

The amplifier 16 is adapted to amplify the output voltage of the hall element 14, and to output the amplified voltage to the comparator 17.

The comparator 17 is adapted to compare the voltage from the amplifier 16 with the reference voltage from the PWM signal producing unit 18, and to output a signal useful for judging whether or not the lens 11 is about to move beyond an infinity-related position, and whether or not the lens 11 is about to move beyond a macro-related position.

The PWM signal producing unit 18 and the lens controller 19 are constituted by, for example, a digital signal processor (hereinafter simply referred to as “DSP”). The PWM signal producing unit 18 is adapted to output a signal produced as a reference voltage to the comparator 17, and to output a signal useful in allowing the lens driver 20 to drive the lens 11. Here, the reference voltage to be outputted by the PWM signal producing unit 18 is adjustable by, for example, a variable register, a program, or the like. The PWM signal producing unit 18 is constituted as pulse width modulation signal producing means of the imaging device according to the present invention.

The lens controller 19 is adapted to output a control signal useful in driving the lens 11 to the lens driver 20 in response to the output signal of the comparator 17. More specifically, the lens controller 19 is adapted to produce a control signal useful in moving the lens 11 within a range defined by the infinity-related position and the macro-related position.

The lens driver 20 is adapted to output an electric signal useful in driving the lens moving means 13 on the basis of the control signal from the lens controller 19.

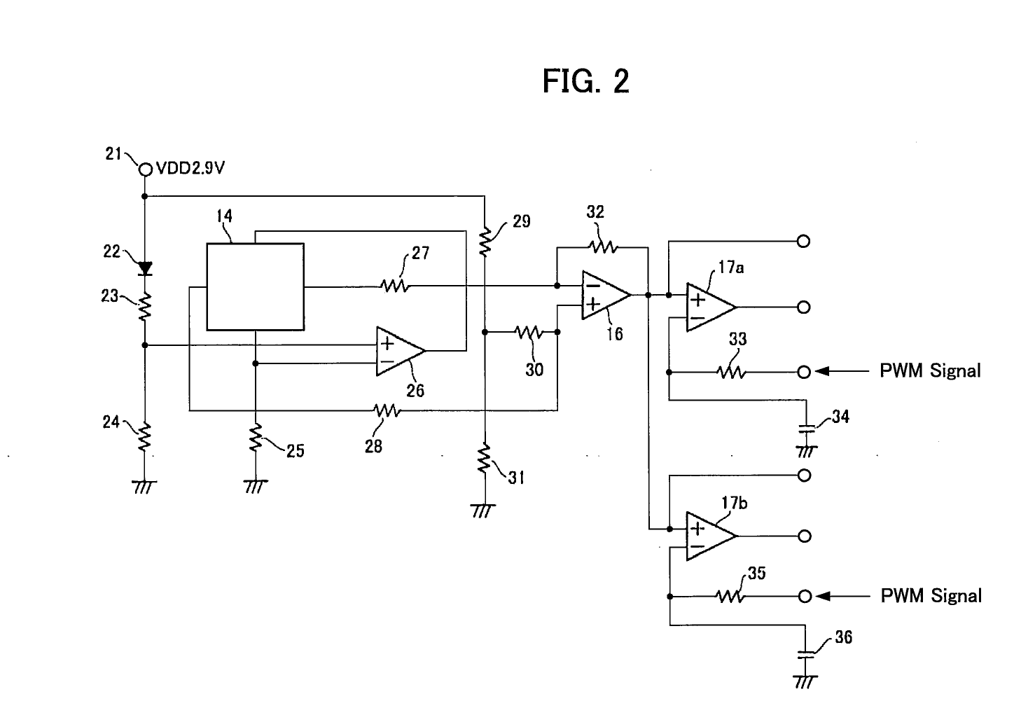

As an example of the circuit configuration of the hall element 14, the constant current circuit 15, the amplifier 16, and the comparator 17 will be then described hereinafter with reference to FIG. 2.

As shown in FIG. 2, the imaging device has a power supply terminal 21 to which a power supply voltage VDD of, for example, 2.9 [volt] is applied. The constant current circuit 15 (see FIG. 1) includes a diode 22, resisters 23 to 25, and an amplifier (hall amplifier) 26. The constant current circuit 15 is adapted to supply a constant current to the hall element 14.

The diode 22 is adapted to perform temperature compensation of the output voltage of the hall element 14 on the basis of the ambient temperature. The hall element 14 has a negative temperature characteristic that the output voltage is reduced in response to the increased ambient temperature. On the other hand, a forward voltage drop of the diode 22 is reduced in response to the increased ambient temperature. A voltage into which the source voltage VDD is divided by the resisters 23 and 24, i.e., a voltage of a noninverting terminal of the amplifier 26 is increased when the forward voltage drop of the diode 22 is reduced by the increased ambient temperature. As a result, an input current of the hall element 14 increased, and the output voltage of the hall element 14 is increased. Therefore, the diode 22 can perform temperature compensation of the output voltage of the hall element 14. Here, the diode 22 functions as temperature compensation means.

The output voltage of the hall element 14 is applied to an inverting terminal and a non-inverting terminal of the amplifier 16 through registers 27 and 28, while a half of the source voltage “VDD” is applied as a bias voltage to the non-inverting terminal of the amplifier 16 through registers 29 and 31.

The output terminal of the amplifier 16 is electrically connected to the non-inverting terminal of the amplifier 16 through a register 32. The gain “α” of the amplifier 16 is characterized by a ratio of a register 32 to a register 27. The amplifier 16 is adapted to amplify the signal from the hall element 14 on the basis of the gain “α”, and to output the amplified signal to the comparators 17a and 17b.

As shown in FIG. 1, the comparator 17 is constituted by comparators 17a and 17b. The comparator 17a is useful in detecting the infinity-related position, while the comparator 17b is useful in detecting the macro-related position. The comparators 17a and 17b are respectively constituted as infinity-related position detecting means and macro-related position detecting means of the imaging device according to the present invention.

The inverting terminal of the comparator 17a is electrically connected to a register 33 and a capacitor 34, while the inverting terminal of the comparator 17b is electrically connected to a register 35 and a capacitor 36. The comparator 17a is adapted to receive the PWM signal through the register 33, while the comparator 17b is adapted to receive the PWM signal through the register 35.

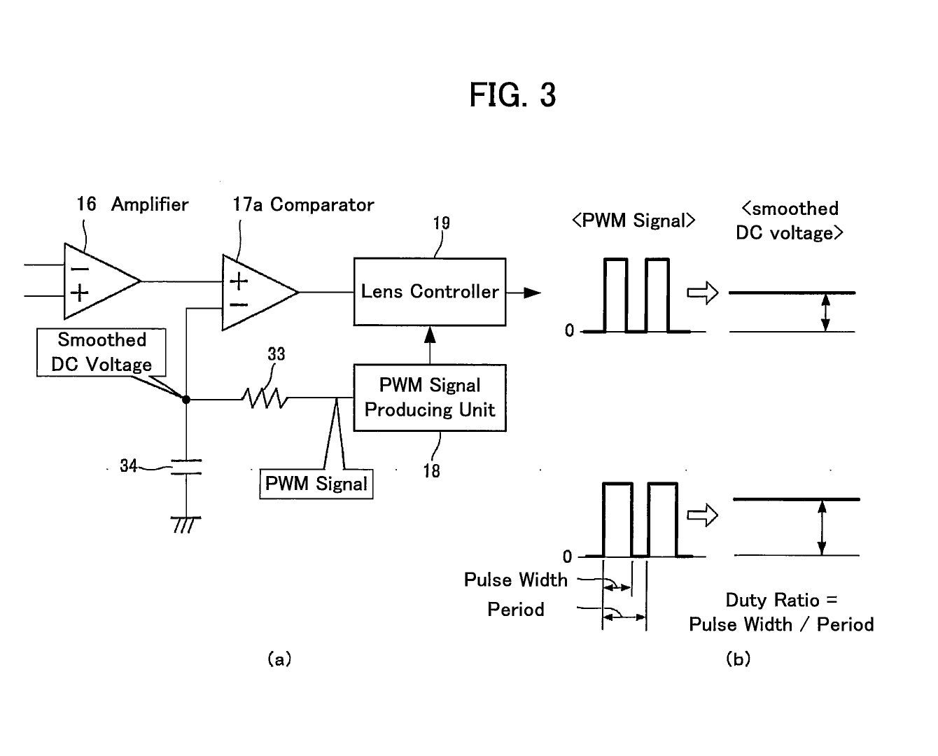

The PWM signal will be then described hereinafter with reference to FIG. 3. FIG. 3(a) is a diagram showing the comparator 17a and its surrounding elements. FIG. 3(b) is a waveform chart showing the PCM signal.

As shown in FIG. 3(a), the resister 33 and the capacitor 34 are collectively constituted as a smoothing circuit for to producing a direct voltage to be outputted as a first reference voltage to the inverting terminal of the comparator 17a by smoothing the PWM signal produced by the PWM signal producing unit 18. As shown in FIG. 3(b), a direct voltage defined as a first reference voltage can be changed with a duty ratio (of a pulse width to a period) when, for example, the duty ratio is changed from a waveform shown in an upper side of FIG. 3(b) to a waveform shown in a lower side of FIG. 3(b). When, for example, a frequency of the PWM signal is changed, the direct voltage defined as a first reference voltage can be changed with more sufficient accuracy.

Additionally, the resister 33, the capacitor 34, and the PWM signal producing unit 18 are collectively constituted as reference voltage producing means. The comparator 17a may have a masking circuit (chattering noise canceling means) for digitally canceling a chattering noise when comparing the signal from the amplifier 16 and the first reference voltage.

As shown in FIG. 3, the comparator 17b and its surrounding circuit are substantially the same in construction as the comparator 17a and its surrounding circuit. As shown in FIG. 2, the PWM signal producing unit 18 is adapted to produce and output a pulse width modulation signal (PWM signal) to a smoothing circuit including a resister 35 and a comparator 17b, while the smoothing circuit is adapted to produce a direct voltage as a second reference voltage by smoothing the PWM signal from the PWM signal producing unit 18, and output the direct voltage to a negative terminal of a comparator 17b.

Here, the comparator 17b may have a masking circuit for digitally canceling a chattering noise before comparing the signal from the amplifier 16 and the first reference voltage. Here, the resister 35, the capacitor 36, and the PWM signal producing unit 18 are collectively constituted as reference voltage producing means.

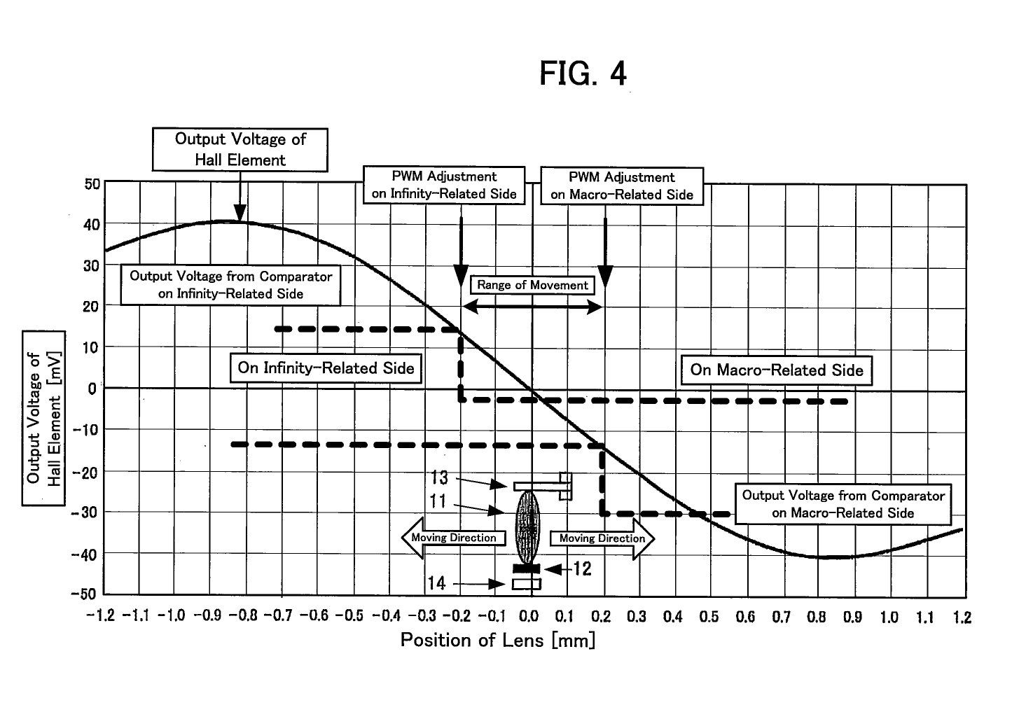

The following description is directed to a method of adjusting the first and second reference voltages. FIG. 4 is a waveform chart showing an example of an output voltage of the hall element 14 to a position of the lens unit 11 of the imaging device 10 according to the embodiment of the present invention. A coordinate system is defined on an optical axis, while an origin of the coordinate system is defined by the infinity-related position and the macro-related position as a reference position. The infinity-related position is defined as being in a minus direction, while the macro-related position is defined as being in a plus direction.

As shown in FIG. 4, the hall element 14 outputs a voltage of approximately 40 [mV] when the lens 11 is at a distance of 0.9 [mm] from the reference position in the minus direction. The output voltage of the hall element 14 is gradually decreased when the lens 11 is moved in a direction toward the macro-related position. The hall element 14 outputs a voltage of approximately −40 [mV] when the lens 11 is at a distance of 0.9 [mm] from the reference position in the plus direction.

When, for example, the lens 11 is moved within a range of ±0.2 [mm] defined by the infinity-related position and the macro-related position, an adjusting device adjusts one of the PMW signals from the PWM signal producing unit 18 in assembling and adjusting stage to ensure that the output signal of the comparator 17a is inverted in signal level at a position of −0.2 [mm], and adjust the other or the PWM signals from the PWM signal producing unit 18 in assembling and adjusting stage to ensure that the output signal of the comparator 17b is inverted in signal level at a position of +0.2 [mm].

From the foregoing description, it will be understood that the imaging device 10 according to the embodiment of the present invention can prevent the lens 11 and its surrounding elements from being moved beyond the range, bumping against elements and being damaged by elements mounted to the housing by reason that the imaging device can determine the infinity-related position and the macro-related position by adjusting the first and second reference voltages in assembling and adjusting stage.

The operation of the imaging device 10 according to the embodiment of the present invention will be then described hereinafter with reference to FIGS. 1 to 4.

Firstly, the constant current circuit 15 produces a current to be supplied to the hall element 14 and drives the hall element 14 by supplying the current to the hall element 14. Then, the hall element 14 generates a voltage in response to the magnetic flux generated by the magnet 12, and outputs the voltage to the amplifier 16. Then, the amplifier 14 amplifies the signal from the hall element 14.

Then, the comparator 17a produces a high level signal or a low level signal by comparing the signal amplified by the amplifier 16 with the first reference voltage, while the comparator 17b produces a high level signal or a low level signal by comparing the signal amplified by the amplifier 16 with the second reference voltage.

When a signal to be used to have the lens 11 move to the infinity-related position or the macro-related position is outputted to the lens controller 19 from the PWM signal producing unit 18, the lens controller 19 controls the lens driver 20 to ensure that the lens moving means 13 moves the lens 11 to the infinity-related position or the macro-related position. When the lens 11 is moved to the infinity-related position or the macro-related position, the magnet 12 is moved with the lens 11. The output voltage of the hall element 14 is changed in response to the position of the magnet 12. As a result, the signal to be inputted to each of the noninverting terminals of the comparators 17a and 17b is changed in response to the position of the magnet 12.

The lens controller 19 monitors the output signals of the comparators 17a and 17b. When the output signal of the comparator 17a or 17b is inverted in signal level, the lens controller 19 makes a judgment that the lens 11 is about to move beyond the infinity-related position or the macro-related position, and stops the lens 11.

From the foregoing description, it will be understood that the imaging device according to the embodiment of the present invention can be reduced in production cost and drastically improved in assembling and adjusting stage in comparison with the conventional imaging device by reason that the lens moving means 13 is adapted to have the lens 11 move over a range defined by the infinity-related position and the macro-related position specified by the comparators 17a and 17b.

The imaging device 10 according to the embodiment of the present invention can be small in construction in comparison with the conventional imaging device to be mounted on the conventional portable terminal by reason that it is not necessary to manually adjust an infinity-related position to be occupied by the lens and a macro-related position to be occupied by the lens in assembling and adjusting stage, and make space for adjustments.

When the imaging device 10 according to the embodiment of the present invention is applied to a portable terminal such as for example a mobile phone, the portable terminal can be improved in production cost and reduced in size in comparison with the conventional portable terminal.

In this embodiment, the magnet 12 functions as magnetic flux generating means for generating a magnetic flux. The hall element 14 functions as position-related voltage outputting means for outputting a voltage indicative of the current position of lens 11 by detecting the magnetic flux of the magnet 12. However, the present invention is not limited to the combination of the magnet 12 and the hall element 14. The imaging device according to the present invention may obtain the above-mentioned advantageous effects by comprising an element for generating a magnetic flux, and an element for outputting an electric signal in response to the magnetic flux.

### INDUSTRIAL APPLICABILITY OF THE PRESENT INVENTION

As will be seen from the foregoing description, the imaging device according to the present invention has an advantageous effect in production cost, and is useful as an imaging device and a portable terminal provided with the imaging device.

1. An imaging device, comprising:
a lens for focusing light from an object;
lens moving means for moving said lens along an optical axis of said lens;
magnetic flux generating means for generating a magnetic flux at a position corresponding to a current position of said lens; and
position-related voltage outputting means for detecting said magnetic flux, and outputting a position-related voltage indicative of said current position of said lens.

2. An imaging device as set forth in claim 1, which further comprises infinity-related position detecting means for detecting an infinity-related position on the basis of a first reference voltage and said position-related voltage, and macro-related position detecting means for detecting a macro-related position on the basis of a second reference voltage and said position-related voltage.

3. An imaging device as set forth in claim 2, in which said lens moving means is adapted to move said lens along said optical axis of said lens within a range defined by said infinity-related position and said macro-related position.

4. An imaging device as set forth in claim 2, which further comprises pulse width modulation signal producing means for producing pulse width modulation signals different in duty ratio from each other, and reference voltage producing means for producing said first and second reference voltages by smoothing said pulse width modulation signals.

5. An imaging device as set forth in claim 1, in which said position-related voltage to be produced by said position-related voltage outputting means is dependent on ambient temperature of said position-related voltage outputting means, and which further comprises temperature compensation means for performing temperature compensation of said position-related voltage in response to said ambient temperature of said position-related voltage outputting means.

6. An imaging device as set forth in claim 2, which further comprises chattering noise preventing means for preventing said infinity-related position detecting means from being affected by a chattering noise at the time of detecting said infinity-related position, and preventing said macro-related position detecting means from being affected by a chattering noise at the time of detecting said macro-related position.

7. A portable terminal comprising an imaging device as set forth in claim 1.
